(19) United States
(12) Patent Application Publication
(10) Pub. No.: US 2022/0390056 A1
(43) Pub. Date: Dec. 8, 2022

(54) Medium Pressure Greater Expansion Tube Plug For Heat Exchangers

(71) Applicant: JNT Technical Services, Inc., Little Ferry, NJ (US)

(72) Inventors: Glenn F. Jorgensen, Little Ferry, NJ (US); Ryan J. Jorgensen, Little Ferry, NJ (US)

(73) Assignee: JNT Technical Services, Inc., Little Ferry, NJ (US)

(21) Appl. No.: 17/825,653

(22) Filed: May 26, 2022

Related U.S. Application Data
(60) Provisional application No. 63/195,296, filed on Jun. 1, 2021.

(51) Int. Cl. F16L 55/11

(52) U.S. Cl. CPC F16L 55/1141

(57) ABSTRACT

A tube plug for securely sealing a tube to be plugged. The tube plug has a housing member with a cylindrical body, an undercut section, and a deformable wall. A ring is rotatably mounted to a post that extends axially from a front end of the housing member and offset from the longitudinal axis so that the ring is eccentric relative to the cylindrical body. An insert member having a threaded shank and a ramped ferrule can be threaded into the body to deform the deformable wall outwardly and into engagement with the tube to be sealed.

### CROSS-REFERENCE TO RELATED APPLICATIONS

The present application claims priority to U.S. Provisional No. 63/195,296, filed on Jun. 1, 2021.

### BACKGROUND OF THE INVENTION

### 1. Field of the Invention

The present invention relates to a plug used to remedy a leaking tube of a heat exchanger and, more particularly, to a heat exchanger tube plug that can expand to a great extent with a limited amount of application force.

### 2. Description of the Related Art

In the construction of boilers and other heat exchange equipment, such as those used in the power generation, oil refining, and chemical industries, there is often a need to seal leaking tubes, pipes and similar conduits that transport steam, liquid or gasses under pressure. This sealing is frequently accomplished by the insertion of a plug into the tube. For example, Applicant has disclosed several such plugs in U.S. Pat. Nos. 5,289,851, 6,883,547, and 6,981,524 that, upon insertion, will expand to sealingly engage the inner surface of a boiler or heat exchanger tube. These devices are generally referred to as mechanical tube plugs.

A large portion, if not the majority, of tube plugging applications are process exchangers with advanced states of tube corrosion. This advanced state of corrosion can cause the tube inside diameter to vary widely since some tubes will be more worn than others in the same heat exchanger. Additionally, manufacturing tolerances can cause more uncertainty, with the actual ID falling +10% to −10% of specification for average wall tubes and +0% to −20% of specification for minimum wall tubes. Existing plugs, including those of Applicant as identified above, have an expansion range of up to only about 0.030 inches, which can be less than the variation found in many process exchangers. As a result, plugs are often incorrectly sized and do not adequately plug the tube to be plugged. Accordingly, there is a need in the art for a plug of a fixed diameter that can expand through a wider range of diameters to avoid the need to be extremely accurate with the tube inside diameter and thus reduce the number of incorrectly sized plugs.

### BRIEF SUMMARY OF THE INVENTION

The present invention is a tube plug that can expand outwardly through a wider range of dimensions to seal a tube to be plugged even if the tube diameter is not accurately known. The tube plug has a housing member with a cylindrical body extending along a longitudinal axis and having a first section with a first outer diameter surrounding threaded bore of a first inner diameter, an undercut section extending from the first section having a second outer diameter that is smaller than the first outer diameter, and a deformable wall extending from the undercut section and having a third outer diameter. The undercut section and the deformable wall surround an inner bore of a second inner diameter that is larger than the first inner diameter. A ring is mounted to a post that extends axially from a front end of the housing member and that is offset from the longitudinal axis so that the ring is eccentric relative to the cylindrical body. An insert member has a threaded shank corresponding to the threaded bore of the housing member and a ramped ferrule positioned about the threaded shank to deform the deformable wall and the undercut section outwardly when the insert member is advanced into housing member by rotation of the threaded shank into the threaded bore. The third outer diameter is larger than the second outer diameter and is smaller than the first outer diameter. The deformable wall includes a series of grooves in an outer surface of the deformable wall. The deformable wall has a tapered inner diameter that is smallest adjacent to the undercut section. The tapered inner diameter of the deformable wall extends along an angle of between 15 to 20 degrees relative to the longitudinal axis of the cylindrical body. The series of grooves of the deformable wall have a depth of between 0.020 and 0.030 inches. The tube plug will expand up to 0.060 inches when the insert member is advanced into the housing member. The undercut section has a first length and the deformable wall has a second length. The first length is at least five times the second length. The deformable wall has a thickness of 0.035 inches. The depth of the series of grooves changes along the second length and increases towards the undercut section.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a side view of a tube plug according to the present invention;

FIG. 2 is a perspective view of a tube plug according to the present invention

FIG. 3 is a longitudinal cross-section of a tube plug according to the present invention;

FIG. 4 is a rear view of a tube plug according to the present invention;

FIG. 5 is a front view of a tube plug according to the present invention; and

FIG. 6 is a cross-sectional view of a housing member according to the present invention showing preferred dimensions.

### DETAILED DESCRIPTION OF THE INVENTION

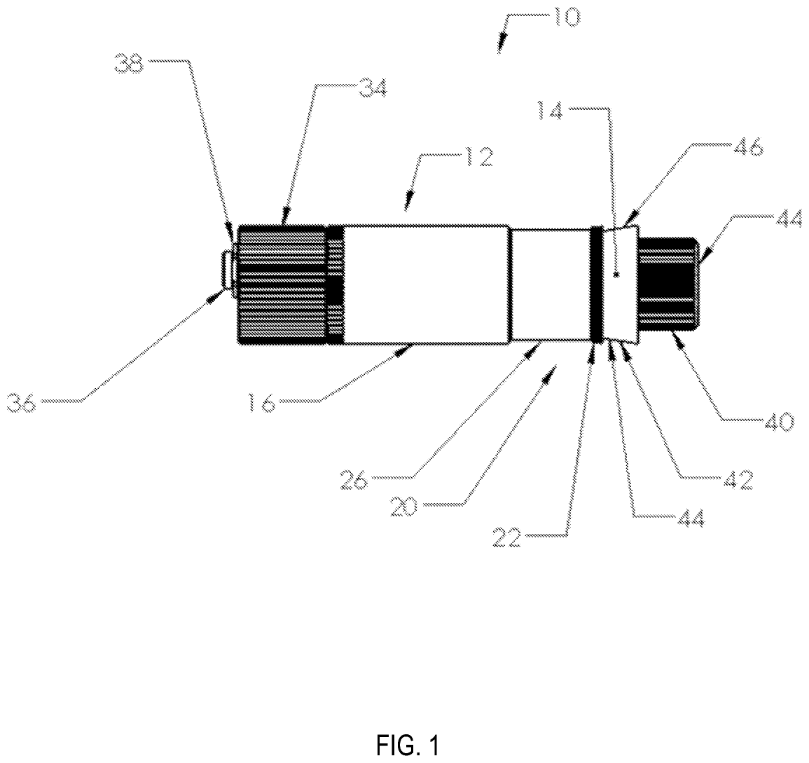

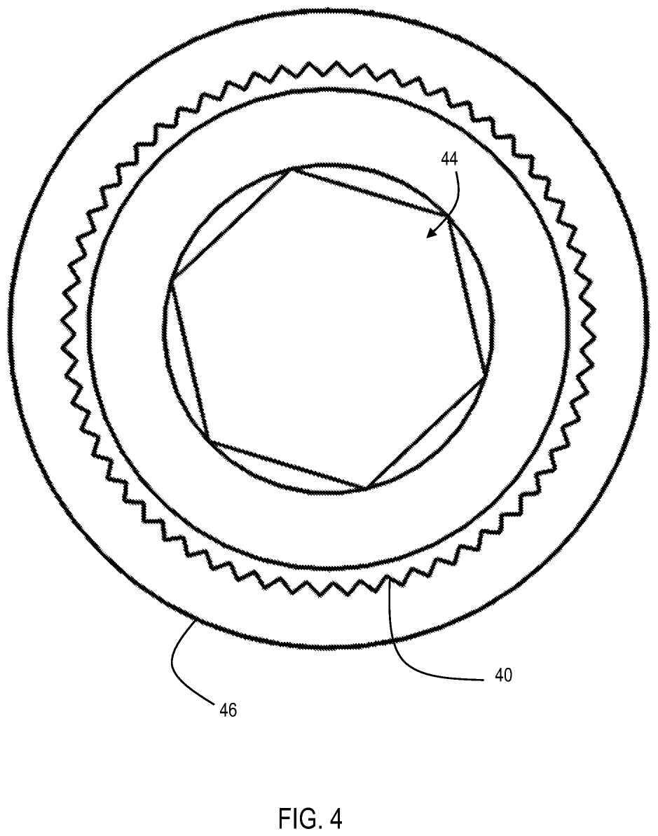

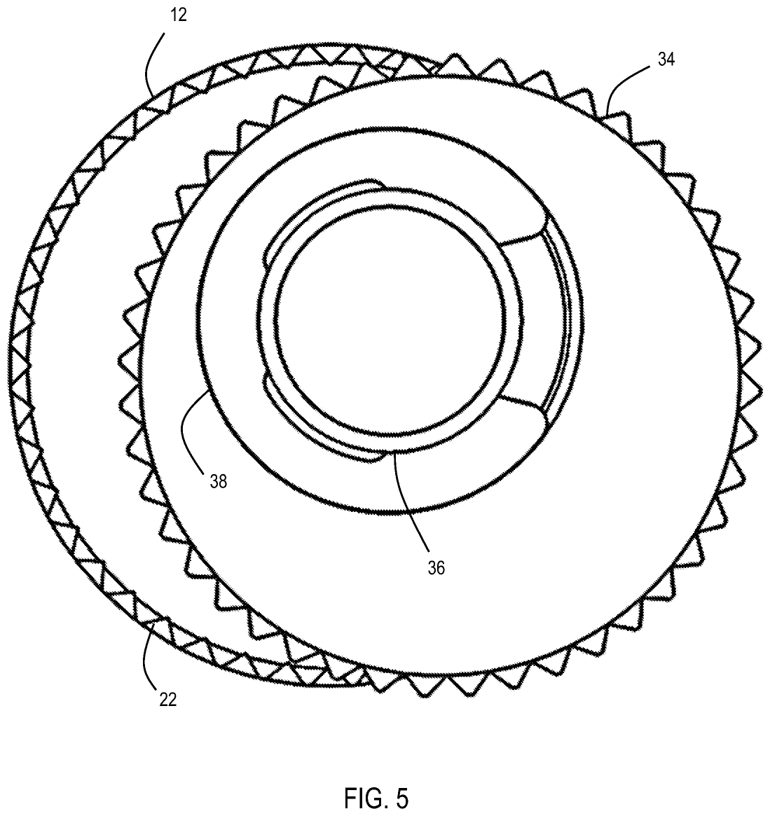

Referring to the figures, wherein like numeral refer to like parts throughout, there is seen in FIGS. 1 through 5 a tube plug 10 made in accordance with the present invention. Plug 10 comprises a housing member 12 and an insert member 14 that can be advanced into housing member 12. Housing member 12 has cylindrical body 16, the rear portion of which is formed with a large open bore 18. Bore 18 is surrounded by relatively thin wall 20 that is deformable and will expand outwardly to provide a seal with a cylindrical opening, such as the aperture of a tube sheet in response to advancement of insert member 14 into bore 18. As seen in FIG. 1, wall 20 includes grooves 22 or serrations that, along with other features, helps achieve the expandability of plug 10 and create an improved seal due to the serrations ‘biting’ into the tube inside surface. Wall 20 also includes undercut section 26, which reduces the expansion forces, otherwise walls 20 may be too thick and require too much force to expand. The combination of the grooves 22 and undercut section 26 reduce the force enough to allow greater expansion than was previously achievable. Plug 10 may be manufactured from various metals including stainless steel, brass, or carbon steel, but other alloys may be used.

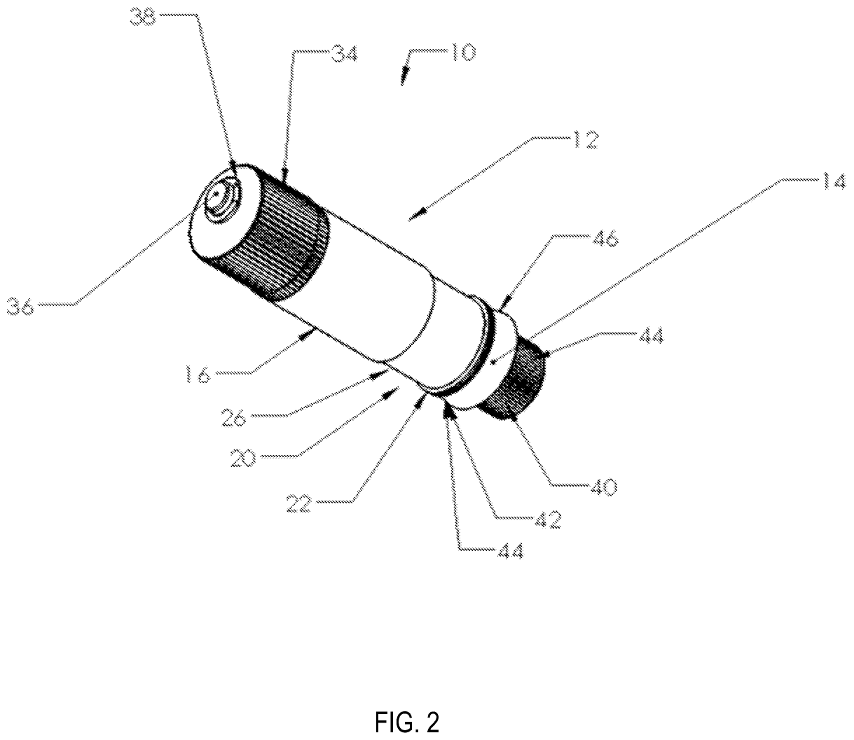

Referring to FIGS. 1 and 2, Housing member 12 includes an eccentric ring 34 coupled to the end of cylindrical body 16 so that cylindrical body 16 is locked against rotation when cylindrical body 16 and eccentric ring 34 are inserted into a tube. For example, eccentric ring 34 may be mounted eccentrically to post 36 relative to a longitudinal axis X-X of housing member 12 and rotatable thereon. Ring 34 is held in place by a clip 38 engaged with post 36. Eccentric ring 34 may have a textured outer surface as seen in FIG. 1 to enhance the frictional engagement with the interior surface of a tube to be plugged.

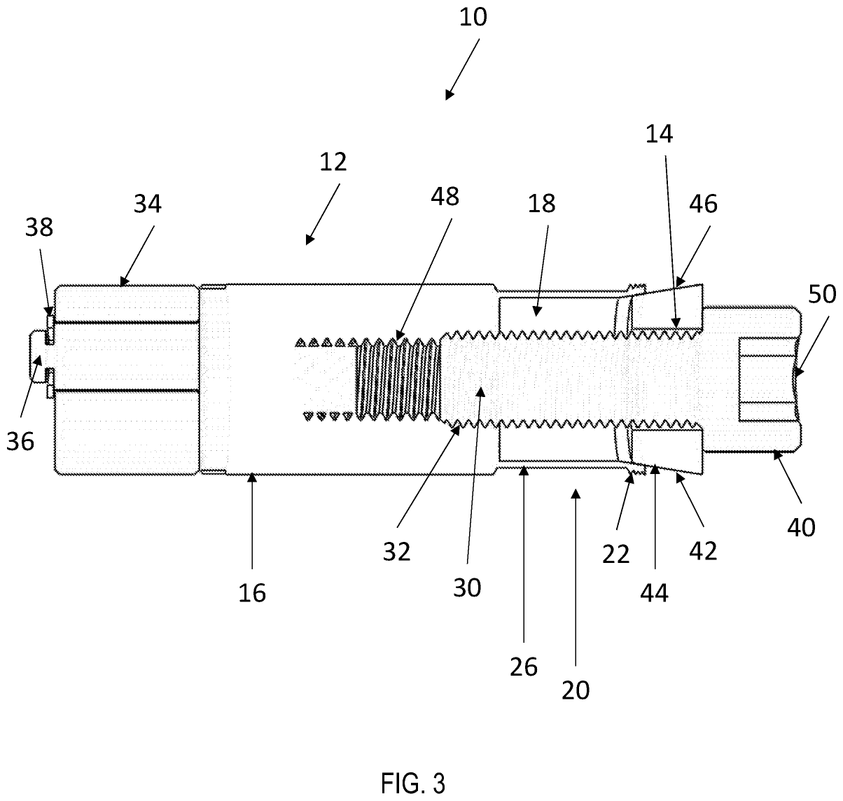

Referring to FIG. 3, insert member 14 comprises a shank 30, at least a portion of which is has external threads 32, that can extend within body 16. A head 40 is fixedly coupled to shank 30. A tapered ferrule 42, which is preferably frustoconical, is rotatably mounted about shank 30 and captured by head 40. Although head 40 and shank 30 are shown as separate structures from ferrule 42, the components could also be integrally formed as a single unit. At least a portion of the interior of bore 18 is a threaded portion 48 to correspond to the threads 32 of shank 30 so that rotation of head 40 relative to cylindrical body 16 can advance insert member 14 into housing member 12. Head 40 preferably includes a driving recess 50 formed therein, such as a hex socket head manual rotation of insert member 14 using a hex driver, but other coupling approaches may be used. Ferrule 42 is dimensioned to have a narrower end 44 that fits inside of bore 18 and a wider end 46 so that advancement of ferrule 42 into bore 18 as a result of rotation of head 40 will cause outward deformation of wall 20.

Rotation of head 40, and the locking of cylindrical body 16 against rotation by eccentric ring 34 in tube, will cause insert member 14 to advance into housing member 12 by the cooperation of threaded shank 30 and threaded portion 48 of bore 18. Advancement of insert member 14 causes ferrule 42 to engage wall 20 and then to deform wall 20 outwardly, thereby engaging the inner surface of a tube into which tube plug 10 has been inserted. Housing member 12 may thus be deployed to seal the tube by inserting plug 10 into the tube to be sealed and rotating insert member 14 to drive expansion of wall 20 into engagement with the tube.

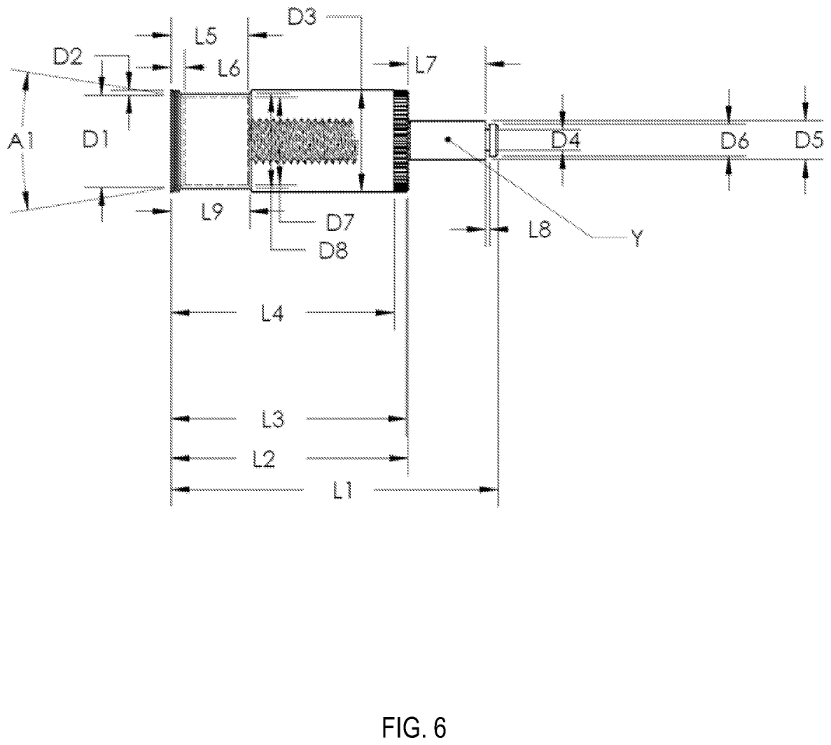

Referring to FIG. 6, the dimensions of plug 10 are configured to provide for enhanced expansion. For example, housing member 12 has a total length L1. Bore 18 has a first diameter D1. Wall 20 includes a taper along angle A1 from a first thickness D2 to a second thickness that is coextensive with outer diameter D3 of cylindrical body 16 and diameter D1 of bore 18 (i.e., second thickness is diameter D3 minus diameter D1) over length L6. Wall 20, over length L6, includes circumferential grooves or serrations that end with the last full valley before L6. The distance from the bottom of the valley to the interior of wall 20 is consistent and corresponds to half the difference between D7 and D8, and the valleys mirror the angle A1 to maintain this relative thickness. Cylindrical body 18 has an undercut section 26 after L6 and along L9 where the diameter is reduced from D3 to D8 after grooves 22 and along L9, effectively reducing the thickness of wall 20 by half of the difference between D3 and D8. This approach reduces the expansion forces required, thus allowing greater expansion of plug 10 without a risk of failure due to excessive torque.

The present invention thus does not simply increase wall thickness to create greater expansion as this would require excessive torque to expand plug 10. Instead, the present invention involves an increase the taper angle A1, which reduces the length of the taper angle L6. This change, however, results in less surface area friction between ferrule 42 and plug body 16. The depth and arrangement of the circumferential grooves 22 (or serrations) have been increased and positioned before the end of L6 to avoid geometries that would result in material failure. Additionally, deeper grooves 22 reduces the effective wall thickness and reduces the installation torque or forces required. The inclusion of undercut section 26 after L6 that continues until the large bore becomes the smaller threaded bore also reduces the effective wall thickness and greatly reduced the torque required for expansion. The reduction in the outside diameter D3 over this section has no effect on the expansion range since this section is not used for expansion. The net result of these major changes from conventional designs is to greatly reduce surface to surface friction forces and material expansion forces to allow plug 10 to achieve greater expansion without galling or other fatigue of the materials.

Bore 18 has a total length L5. Cylindrical body 18 has a length L2, which includes a textured portion of length L2 minus L5 and a chamfer of length L2 minus L3. Post 36 is offset from the longitudinal axis X-X by distance Y and has a bearing surface of length L7 and an outer diameter D5 to support eccentric ring 34. Post 36 includes a gap of length L8 and outer diameter D4 that accepts clip 38 to retain ring 34 in place on post 36, and a tip of outer diameter D6 that extends through eccentric ring 34 for the remaining of the total length L1 of housing member 12. The dimensions of insert member 14 are selected to correspond to these dimensions. For example, ferrule 42 should taper from an outer diameter corresponding to D1 to an outer diameter corresponding to D3 so that advancement of ferrule 42 will expand wall 20 outwardly.

Plug 10 is designed to provide for an expansion of wall 20, which is generally restricted to two times the thickness of wall 20 as ferrule 42 cannot have a larger outer diameter than cylindrical body 16. To achieve the increased expansion range of the present invention, the preferred thickness of wall 20 is 0.035 inches with grooves of between 0.020 and 0.030 inches and a taper angle A1 of 15-20 degrees, which synergistically cooperate to reduce installation forces and stresses on tube 10 significantly while allowing the appropriate amount of torque for installation of tube 10. Finally, as a result of taper angle A1, a longer ferrule 42 is required and, correspondingly, a longer plug 10 with a longer bore 18 to accept longer ferrule 42.

In an exemplary embodiment, tube plug 10 may be dimensioned as set forth in Table 1 below:

TABLE 1

| Dimension | Value (inches or degrees) |
|---|---|
| D1 | 0.660 |
| D2 | 0.035 |
| D3 | 0.730 |
| D4 | 0.150 |
| D5 | 0.280 |
| D6 | 0.230 |
| D7 | 0.628 |
| D8 | 0.678 |
| L1 | 2.345 |
| L2 | 1.700 |
| L3 | 1.690 |
| L4 | 1.600 |
| L5 | 0.555 |
| L6 | 0.100 |
| L7 | 0.555 |
| L8 | 0.032 |
| L9 | 0.564 |
| A1 | 18.18 |
| Y | 0.090 |

Although plug 10 may be provided in different outer diameters to accommodate differently sized tubes to be plugged, the ability of plug 10 to expand outwardly up to 0.060 inches allows one sized plug 10 to be used when the inner diameter of the tube to be plugged is not precisely know. Regardless of the outer diameter of plug 10, cylindrical body 16 and rotation by eccentric ring 34 have the same diameter. Bore 18 is dimensioned based on the outer diameter of plug 10 to provide a constant wall thickness and taper as described above. The dimensions of ferrule 42 and body 16 vary proportionally. Head 40 and shaft 30 may be the same dimensions for various sizes plugs 10. For example, a 0.390 inch diameter to 0.560 inch diameter body 16 can use a 5/16 inch-24 screw. Larger range plugs 10 having a 0.570 inch diameter to 0.740 inch diameter body 16 can use a ⅜ inch-24 screw. Regardless of the size of plug 10, the combination of wall thickness, taper, and outer grooves 22 as described herein can result in an expansion of about 0.060 inches, which is at least twice that possible with conventional designs. Plug 10 is particularly useful in medium pressure applications, which generally involves tubes that are used in heat exchange systems having pressure levels of zero to 2500 pounds per square inch.

Wall thickness may thus increase in proportion to the expansion range. The grooves 22 of wall 20 need to be deeper in proportion to the wall thickness increase in order to reduce the necessary installation forces/stresses as much as possible. Taper angle A1 may then be reduced just enough to achieve an acceptable installation torque. The length of ferrule 24 and overall plug length increase inversely proportional to the change in taper angle A1 (less taper angle, more length) and the plug length can be increased to additionally reduce concentrated stresses at the 90 degree geometry change inside the body 16 of plug 10.

What is claimed is:

1. A tube plug, comprising:
a housing member having a cylindrical body extending along a longitudinal axis and having a first section with a first outer diameter surrounding threaded bore of a first inner diameter, an undercut section extending from the first section having a second outer diameter that is smaller than the first outer diameter, and a deformable wall extending from the undercut section and having a third outer diameter, wherein the undercut section and the deformable wall surround an inner bore of a second inner diameter that is larger than the first inner diameter;
a ring mounted to a post that extends axially from a front end of the housing member and offset from the longitudinal axis so that the ring is eccentric relative to the cylindrical body; and
an insert member having a threaded shank corresponding to the threaded bore of the housing member and a ramped ferrule positioned about the threaded shank to deform the deformable wall and the undercut section outwardly when the insert member is advanced into housing member by rotation of the threaded shank into the threaded bore.

2. The tube plug of claim 1, wherein the third outer diameter is larger than the second outer diameter.

3. The tube plug of claim 2, wherein the third outer diameter is smaller than the first outer diameter.

4. The tube plug of claim 3, wherein the deformable wall includes a series of grooves in an outer surface of the deformable wall.

5. The tube plug of claim 4, wherein the deformable wall has a tapered inner diameter that is smallest adjacent to the undercut section.

6. The tube plug of claim 5, wherein the tapered inner diameter of the deformable wall extends along an angle of between 15 to 20 degrees relative to the longitudinal axis of the cylindrical body.

7. The tube plug of claim 6, wherein the series of grooves of the deformable wall have a depth of between 0.020 and 0.030 inches.

8. The tube plug of claim 7, wherein the tube plug will expand up to 0.060 inches when the insert member is advanced into the housing member.

9. The tube plug of claim 8, wherein the undercut section has a first length and the deformable wall has a second length.

10. The tube plug of claim 9, wherein the first length is at least five times the second length.

11. The tube plug of claim 10, wherein the deformable wall has a thickness of 0.035 inches.

12. The tube plug of claim 11, wherein the depth of each of the series of grooves changes along the second length.

13. The tube plug of claim 12, wherein the depth of the series of grooves increases towards the undercut section.
